(19) United States
(12) Patent Application Publication
(10) Pub. No.: US 2017/0055487 A1
(43) Pub. Date: Mar. 2, 2017

(54) TELESCOPIC CHAIN TYPE PET CAGE DOOR

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/246,342

(22) Filed: Aug. 24, 2016

(30) Foreign Application Priority Data
Aug. 24, 2015 (CN) 201520642264.7

(51) Int. Cl. A01K 1/02; E06B 3/44; E05F 11/54; E06B 3/48

(52) U.S. Cl. CPC A01K 1/0245; E06B 3/48; E06B 3/44; E05F 11/54

(57) ABSTRACT

A telescopic chain type pet cage door includes a spring case, a rotary type lifting handle, a telescopic door composed of a chain plate and a crossbar, and guide rails; the guide rails are configured longitudinally; when the telescopic chain type pet cage door is closed, the chain plate and the crossbar are unfolded, and the lifting handle is hooked and locked by a drag hook of the spring case; when the telescopic chain type pet cage door needs to be opened, the lifting handle rotates to be separated from the drag hook of the spring case to upwards drive the chain plate and the crossbar to move upwards and to be shrunk in the guide rails.

### CROSS-REFERENCE TO RELATED APPLICATIONS

This Application claims the priority of Chinese Patent Application No. 201520642264.7, filed on Aug. 24, 2015, the disclosure of which is incorporated by reference in its entirety.

### TECHNICAL FIELD

The present invention relates to a pet cage door, in particular to a telescopic chain type pet cage door, belonging to the technical field of pet cages.

### BACKGROUND ART

Regarding the existing metal (e.g., iron) wire mesh cage for pet raising, a door capable of being opened and closed is disposed on one side of the cage, and the door is generally of a rotating type or a sliding type; regardless of the rotating type or the sliding type, the door is generally locked via a bolt; during use, the bolt is capable of moving left and right or up and down in need of manpower, and is thus inconvenient to operate, and is relatively laborious to operate especially in case that the iron wire mesh cage is rusted a litter or insufficient to lubricate. In addition, as an independent part, the bolt is not integrated with the whole pet cage and is even separated from an iron wire hole sometimes, and the phenomenon of bolt lost brings unnecessary troubles to users.

In the meantime, the existing sliding type pet cage door occupies a relatively large space, and the door will integrally moves upwards by a very long distance when being opened, resulting in inconvenient operation and influence on the use experience of people.

### SUMMARY OF THE INVENTION

The technical problem to be solved by the present invention is that: the existing sliding door of an iron wire pet cage is inconvenient to operate and relatively laborious, and a bolt may be even separated from an iron wire hole sometimes, resulting in a phenomenon of bolt lost; in the meantime, the existing sliding type pet cage door occupies a relatively large space, and the door will integrally moves upwards by a very long distance when being opened, resulting in inconvenient operation.

Objects of the present invention may be realized in the following manners:

a telescopic chain type pet cage door comprises a spring case 1, a rotary type lifting handle 2, a telescopic door composed of a chain plate 3 and a crossbar 4, and guide rails 5; the guide rails 5 are configured longitudinally; when the telescopic chain type pet cage door is closed, the chain plate 3 and the crossbar 4 are unfolded, and the lifting handle 2 is hooked and locked by a drag hook la of the spring case 1; and when the telescopic chain type pet cage door needs to be opened, the lifting handle 2 rotates to be separated from the drag hook la of the spring case 1 to drive the chain plate 3 and the crossbar 4 to move upwards or transversely and to be shrunk in the guide rails 5.

Further, the guide rails 5 may be square guide rails.

Further, the surface of a part where the drag hook la may be in contact with the lifting handle 2 is of a circular arc.

Further, a pair of guide rails 5 may be configured and distributed on the upper side and the lower side or the left side and the right side of the pet cage door.

Embodiments of the present invention may have one or more of the following beneficial effects:

1) the telescopic chain type pet cage door is capable of realizing automatic unlocking and very labor-saving to operate.

2) The actions of unlocking and opening the door of the pet cage are coherent and very convenient to operate.

3) No bolt needs to be used, so that parts of the bolt are reduced and the phenomenon of lost of parts cannot happen.

4) The pet cage door may be automatically shrunk after being lift upwards, so that the lifting amplitude is effectively reduced, the operation is more convenient, and the upper space occupied by the cage door can be reduced.

### BRIEF DESCRIPTION OF THE DRAWINGS

FIG. 1 is a stereogram of the cage when the vertically-opened telescopic chain type pet cage door is at a closed state.

FIG. 2 is a partial enlarged diagram of FIG. 1.

FIG. 3 is a partial enlarged diagram of FIG. 2.

FIG. 4 is a stereogram of the cage when the vertically-opened telescopic chain type pet cage door is at an opened state.

FIG. 5 is a partial enlarged diagram of FIG. 4.

FIG. 6 is a stereogram of the cage when the laterally-opened telescopic chain type pet cage door is at a closed state.

FIG. 7 is a stereogram of the cage when the laterally-opened telescopic chain type pet cage door is at a closed state.

In FIGs., the spring case 1, the lifting handle 2, the chain plate 3, the crossbar 4, the guide rails 5 and the drag hook 1a are marked.

### DETAILED DESCRIPTION

The present invention will be further illustrated below with specific examples and the attached drawings.

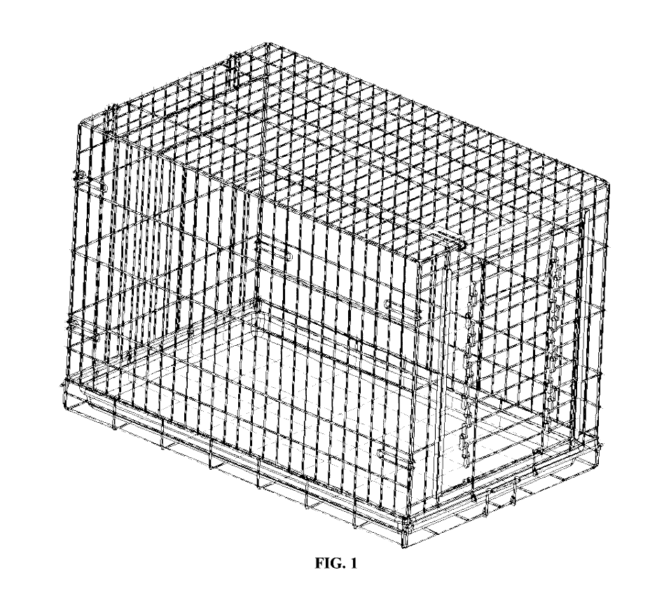

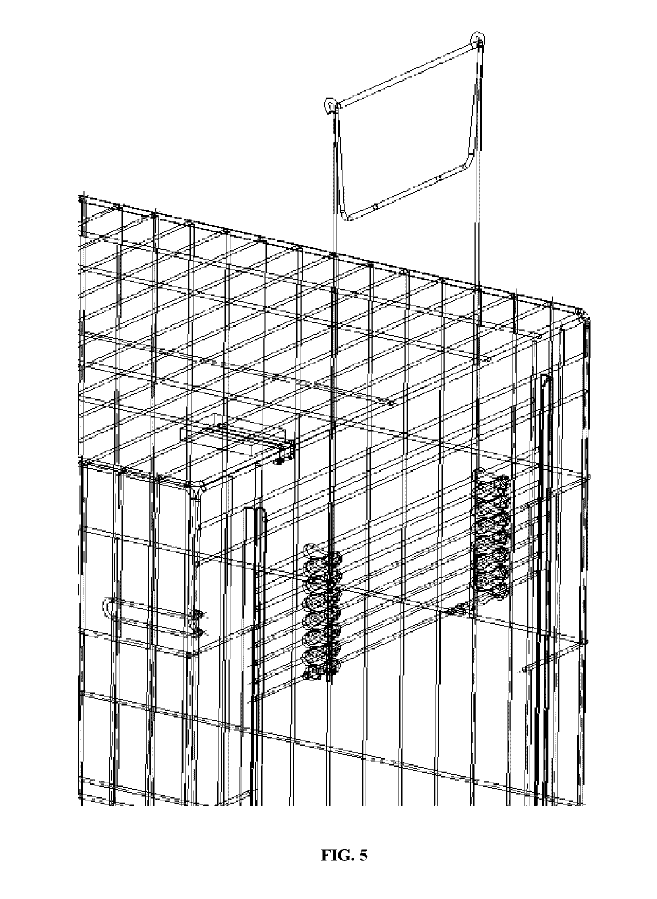

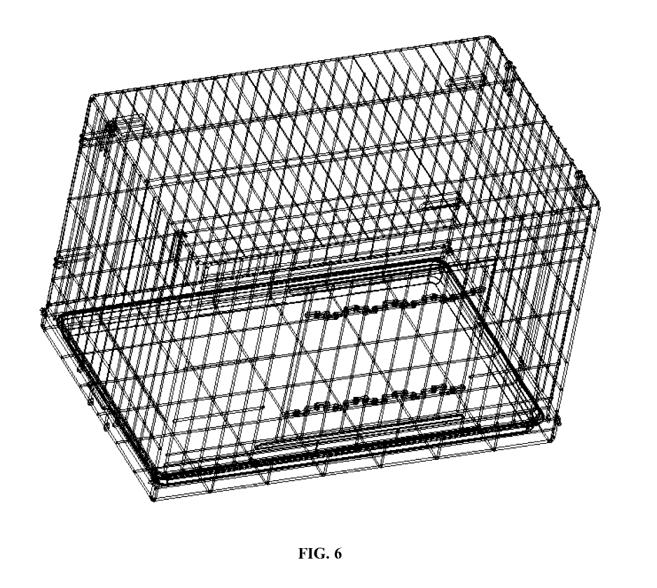

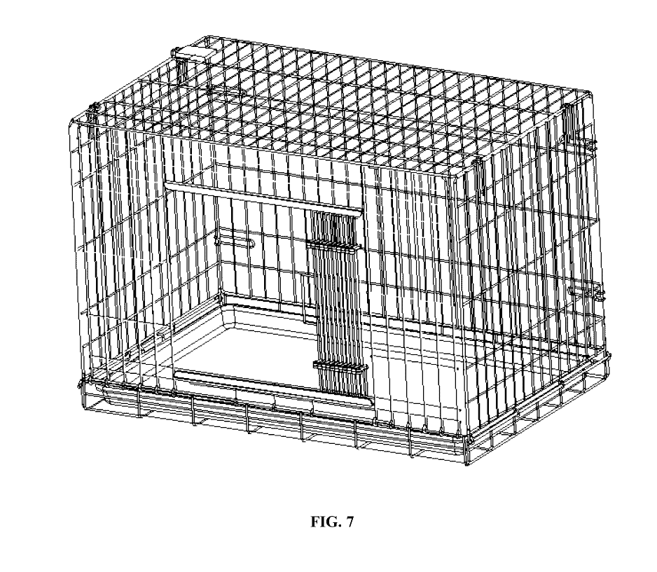

By reference to FIG. 1 to FIG. 5, a telescopic chain type pet cage door comprises a spring case 1, a rotary type lifting handle 2, a telescopic door composed of a chain plate 3 and a crossbar 4, and guide rails 5; the guide rails 5 are configured longitudinally; when the telescopic chain type pet cage door is closed, the chain plate 3 and the crossbar 4 are unfolded, and the lifting handle 2 is hooked and locked by a drag hook la of the spring case 1; and when the telescopic chain type pet cage door needs to be opened, the lifting handle 2 rotates to be separated from the drag hook la of the spring case 1 to upwards drive the chain plate 3 and the crossbar 4 to move upwards and to be shrunk in the guide rails 5.

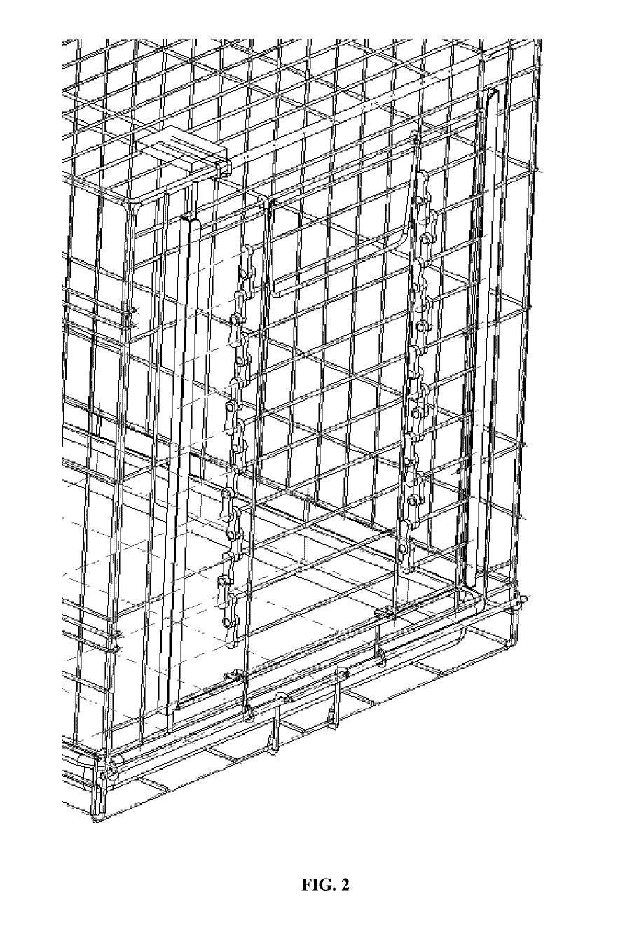

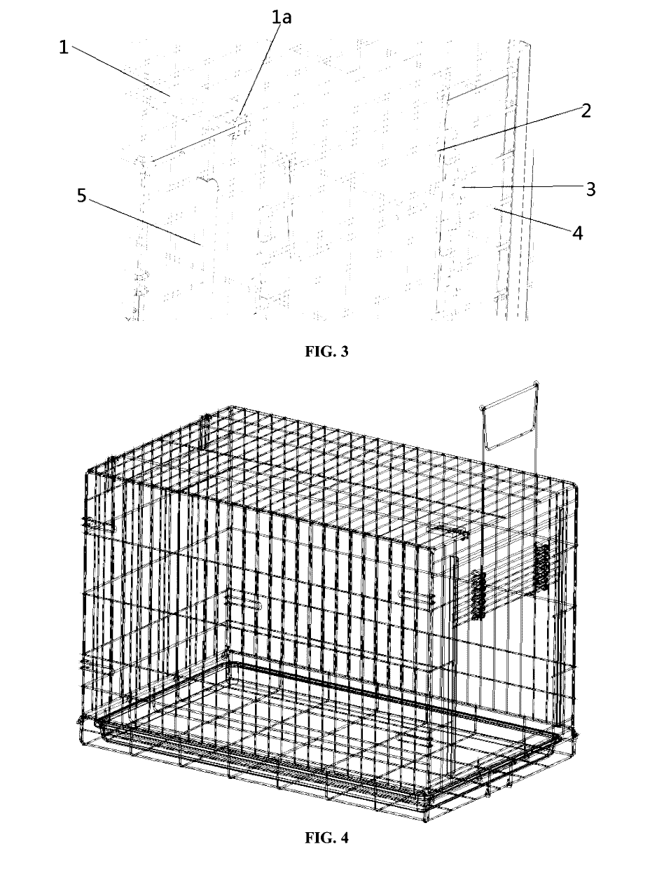

By reference to FIG. 2 and FIG. 3, the guide rails 5 are square guide rails.

By reference to FIG. 3, the surface of a part where the drag hook la is in contact with the lifting handle 2 is of a circular arc.

By reference to FIG. 2 and FIG. 3, a pair of guide rails 5 is configured and distributed on both sides of the pet cage door.

The telescopic chain type pet cage door disclosed by the invention is capable of realizing automatic unlocking and very labor-saving to operate; actions of unlocking and opening the door of the pet cage are coherent and convenient to operate; no bolt needs to be used, so that parts of the bolt are reduced, and the phenomenon of lost of parts cannot happen; and the pet cage door may be automatically shrunk after being lift upwards, so that the lifting amplitude is effectively reduced, the operation is more convenient, and the upper space occupied by the cage door can be reduced.

What is claimed is:

1. A telescopic chain type pet cage door, comprising:
a spring case (1);
a rotary type lifting handle (2);
a telescopic door composed of a chain plate (3);
a crossbar (4); and
guide rails (5),
wherein the guide rails (5) are configured longitudinally such that:
when the telescopic chain type pet cage door is closed, the chain plate (3) and the crossbar (4) are unfolded, and the lifting handle (2) is hooked and locked by a drag hook (1a) of the spring case (1), and
when the telescopic chain type pet cage door needs to be opened, the lifting handle (2) rotates to be separated from the drag hook (1a) of the spring case (1) to drive the chain plate (3) and the crossbar (4) to move upwards or transversely and to be shrunk in the guide rails (5).

2. The telescopic chain type pet cage door according to claim 1, wherein the guide rails (5) are square guide rails.

3. The telescopic chain type pet cage door according to claim 1, wherein the surface of a part where the drag hook (1a) is in contact with the lifting handle (2) is of a circular arc.

4. The telescopic chain type pet cage door according to claim 1, wherein a pair of guide rails (5) are configured and distributed on the upper side and the lower side or the left side and the right side of the pet cage door.
